(19) United States
(12) Patent Application Publication
(10) Pub. No.: US 2023/0002129 A1
(43) Pub. Date: Jan. 5, 2023

(54) BOX WITH INTERCHANGEABLE INSERT

(71) Applicant: GLW & CO., Newport Beach, CA (US)

(72) Inventors: Bryan Ball, Newport Beach, CA (US); Summer Ball, Newport Beach, CA (US)

(21) Appl. No.: 17/862,261

(22) Filed: Jul. 11, 2022

Related U.S. Application Data
(63) Continuation of application No. 16/744,034, filed on Jan. 15, 2020, now abandoned.
(60) Provisional application No. 62/792,854, filed on Jan. 15, 2019.

(51) Int. Cl. B65D 51/24; A45C 11/16; G09F 23/00

(52) U.S. Cl. CPC B65D 51/245; A45C 11/16; G09F 23/00; B65D 2251/065; G09F 2023/0025

(57) ABSTRACT

A container device with an interchangeable insert is disclosed. In some embodiments, the present disclosure generally provides a practical, efficient and affordable solution that allows for changing an insert of the lid of a box, for example, a jewelry box.

### CROSS-REFERENCE TO RELATED APPLICATIONS

This application claims priority pursuant to 35 U.S.C. § 119(e) to U.S. Provisional Patent Application No. 62/792,854, filed Jan. 15, 2019, the disclosure of which is hereby incorporated by reference in its entirety.

### FIELD

The subject matter described herein relates generally to a container device, and particularly to a box with interchangeable insert for the lid.

### BACKGROUND

Container devices, such as jewelry boxes, may have brand or logo imprinted on the top, for example on the lids as a marketing tool. However, brands or logo may change. In other instances, stores or manufacturers that provide their own boxes may want to change the marking on the boxes to different designs for some time-limited marketing campaign, or for other reasons. With the current container or boxes, stores will have to order new boxes every time a change is needed.

Thus, there is a need for a container device or box with an interchangeable insert in the lid for easy and cost-efficient change of marketing marks, without the above mentioned and other disadvantages.

### SUMMARY

Provided herein are example embodiments of a container device with an interchangeable insert. In some embodiments, the present disclosure generally provides a practical, efficient and affordable solution that allows for changing an insert of the lid of a box, for example, a jewelry box. The interchangeable insert may be positioned on a top surface of the lid so that the insert may be removed and replaced with another insert. In some embodiments, the insert may fit into a recess on the lid.

The insert may have a shape with multiple sides, for example, a square shape, an octagon shape, a triangle shape, etc. Or the insert may have a substantially round shape, or another shape.

Other configurations, devices, methods, features and advantages of the subject matter described herein will be or will become apparent to one with skill in the art upon examination of the following figures and detailed description. It is intended that all such additional configurations, devices, methods, features and advantages be included within this description, be within the scope of the subject matter described herein and be protected by the accompanying claims. In no way should the features of the example embodiments be construed as limiting the appended claims, absent express recitation of those features in the claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 illustrates exemplary jewelry boxes and interchangeable inserts, according to some embodiments of the present disclosure.

FIG. 2 illustrates the boxes of FIG. 1 with the lids removed, according to some embodiments of the present disclosure.

FIG. 3 illustrates the inserts fitly inserted into the indented receiving spaces of some exemplary boxes, according to some embodiments of the present disclosure.

FIG. 4 illustrates perspective views of the boxes of FIG. 1 with the lids and inserts installed, according to some embodiments of the present disclosure.

FIG. 5 illustrates top view of some other exemplary jewelry boxes and interchangeable inserts, according to some embodiments of the present disclosure.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

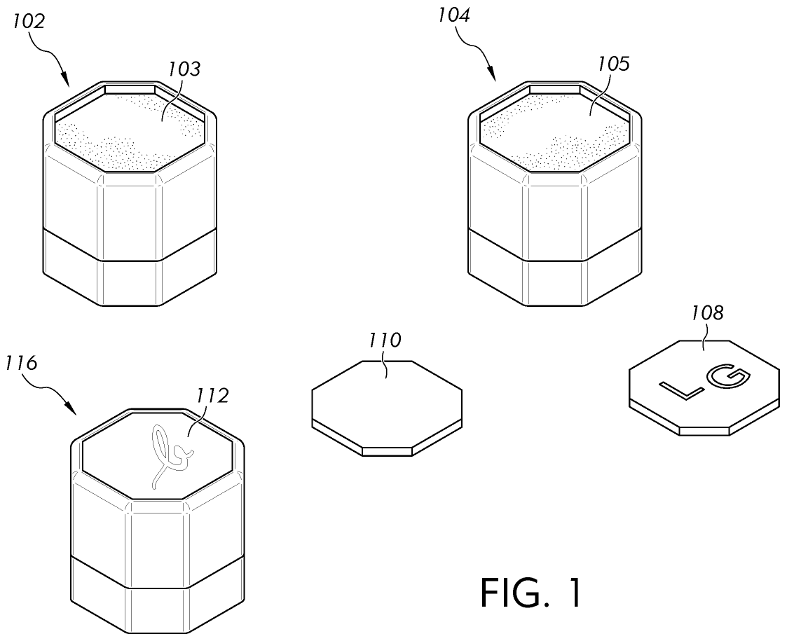

Shown in FIG. 1 are the top view of some exemplary jewelry boxes and interchangeable inserts, according to some embodiments. The lids of the boxes 102 and 104 are shown having a recess or indented receiving space 103 and 105 respectively that is sized and shaped to fitly receive either insert 108, 110, or 112. The lid of the box 116 is shown with the insert 112 already inserted into an indented receiving space. The insert may be secured to the indented receiving space using a suitable mechanism such as adhesion, hook and loop (e.g., Velcro™), tight fit, etc.

The indented receiving spaces and inserts in FIG. 1 are shown with a shape of an octagon. However, the intended receiving space and corresponding insert may be of any shape and size. For example, an indented receiving space and corresponding insert may have a shape with multiple sides, for example, a square shape, an octagon shape, a triangle shape, etc. Or the insert may have a substantially round shape, or another shape.

The insert may be made of metal, plastic, or any suitable material. The insert may include engraving, prints, decals, and other suitable marking on at least one of its surfaces.

In some exemplary applications, a user may remove an insert from the lid of a box and interchange it with another insert with similar shape and size.

In some embodiments, the recess or indented receiving space may have a depth substantially equal to the thickness of the corresponding interchangeable insert. In these embodiments, when the insert is inserted or installed into the indented receiving space, the top surface of the insert is flush with the top edge of the lid. In some embodiments, the recess or indented receiving space may not have a depth equal to the thickness of the corresponding interchangeable insert. In these embodiments, when the insert is inserted or installed into the indented receiving space, the top surface of the insert is not flush with the top edge of the lid.

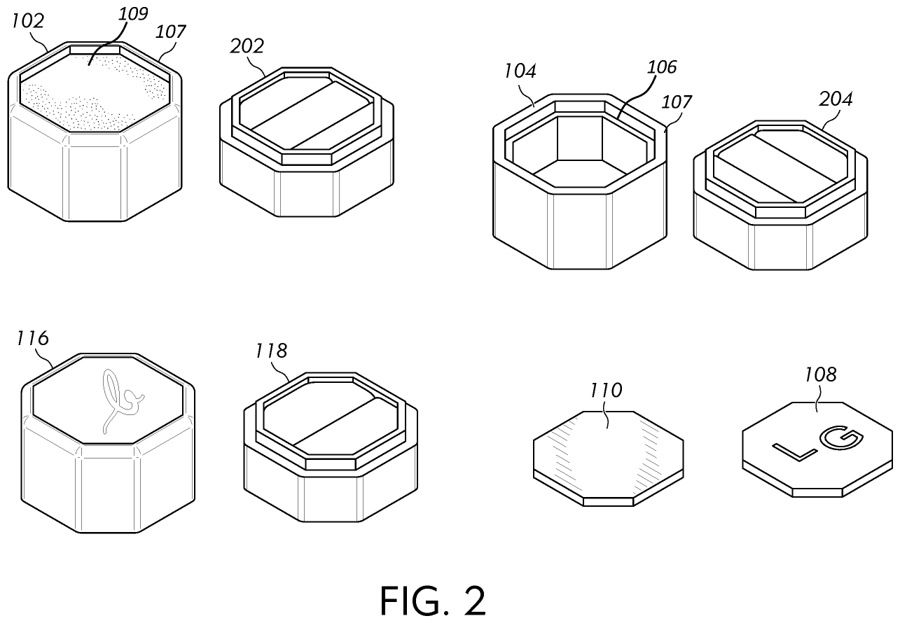

FIG. 2 shows the boxes in FIG. 1 with the lids removed, showing, for example, interior view of bottom part 202 of box 102, interior view of bottom part 204 of box 104, and interior view of bottom part 118 of box 116.

In some embodiments, as shown in the example of box 102, the receiving space may include a platform 109. The platform 109 is sized to receive an insert, for example, insert 108 or 110. The platform 109 may be in proximity to the top edge 107 of the lid.

In some embodiments, as shown in the example of box 104, the lid may include a ledge 106 along the inside walls of the lid. The width of the ledge 106 is sized to securely receive an insert, for example, insert 108 or 110. The ledge 106 may be in proximity to the top edge 107 of the lid.

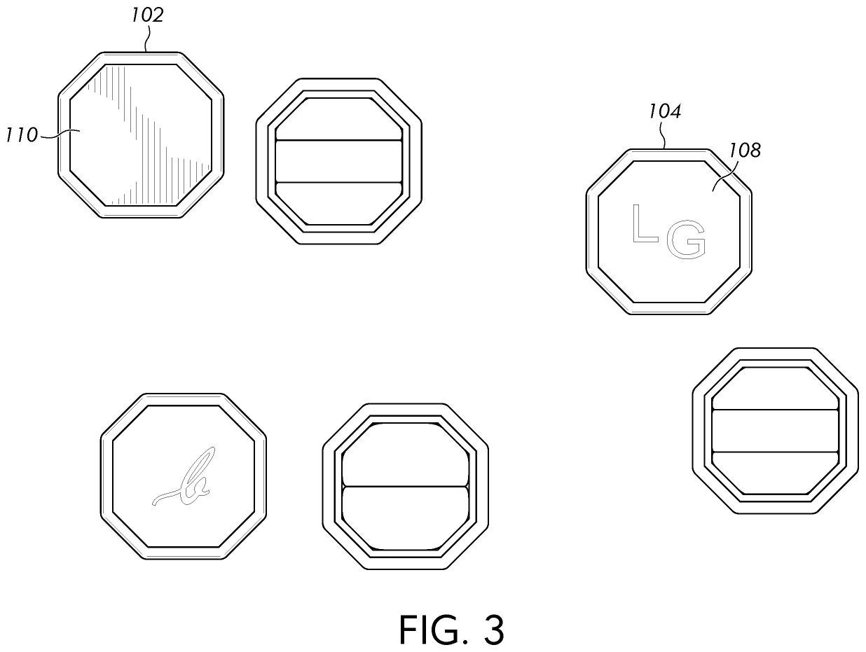

FIG. 3 shows the insert 110 fitly inserted into the indented receiving space 103 of box 102, and the insert 108 fitly inserted into the indented receiving space 105 of box 104. In this example, because the inserts 110 and 108 have the same size and shape, and the indented receiving shapes of boxes 102 and 104 also have the same size and shape, the inserts 110 and 108 are interchangeable with either box 102 or 104. Insert 108 and 110 may be secured to the respective indented receiving space 105 and 103 using a suitable mechanism such as adhesion, hook and loop, tight fit, etc.

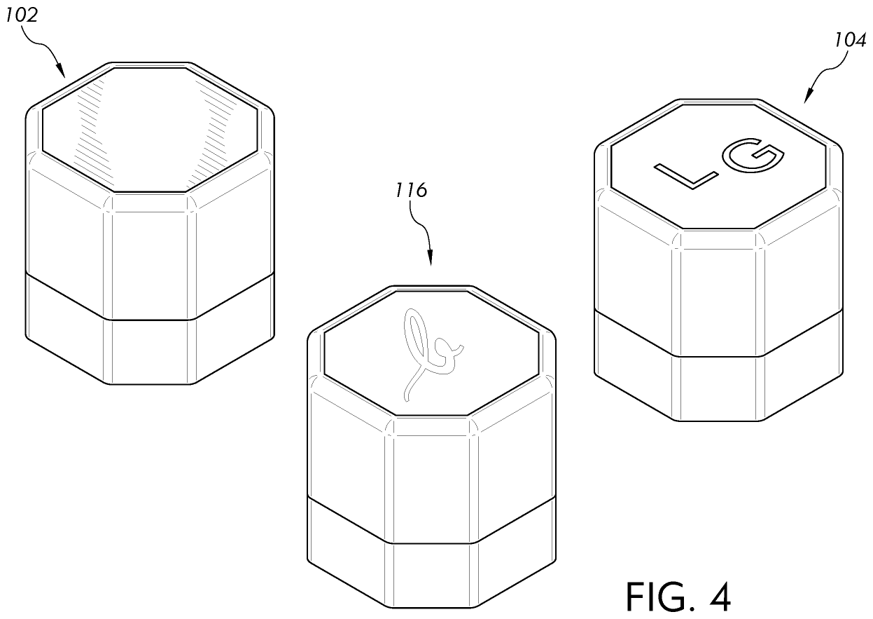

FIG. 4 shows perspective views of the boxes 102, 104 and 116 of FIG. 1 with the lids and inserts installed.

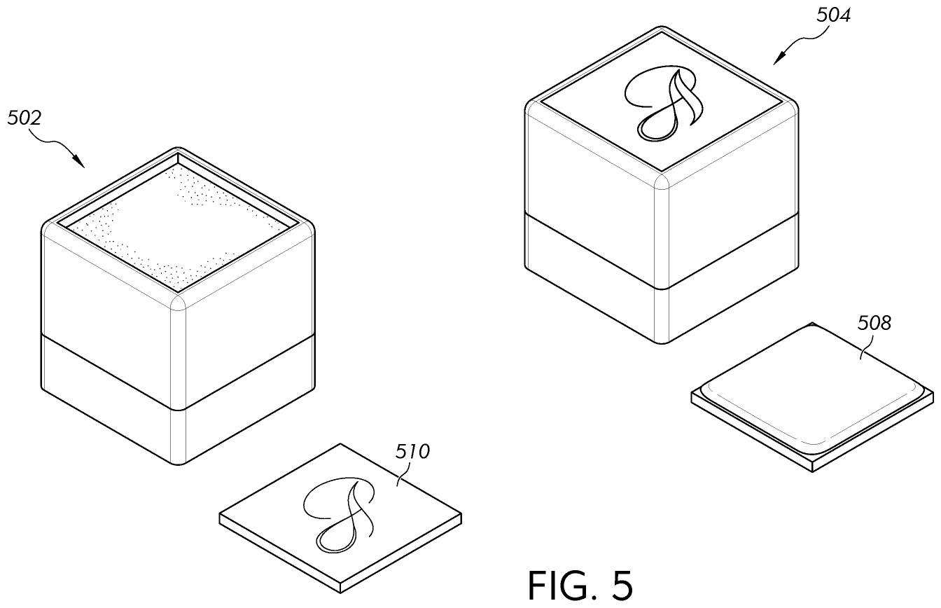

Shown in FIG. 5 are the top view of some exemplary jewelry boxes and interchangeable inserts, according to some embodiments. The lids of the boxes 502 and 504 are shown having a recess or indented receiving space that is sized and shaped to fitly receive either insert 508 or 510.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

What is claimed is:

1. A box with interchangeable insert, comprising:
a bottom main part;
a lid having an indented receiving space that is shaped and sized to receive an interchangeable insert; and
the interchangeable insert shaped and sized to fit into the indented receiving space.

2. The box of claim 1, wherein the indented receiving space has a depth substantially equal to a thickness of the interchangeable insert.

3. The box of claim 1, wherein the indented receiving space has a depth not equal to a thickness of the interchangeable insert.

4. The box of claim 1, wherein the indented receiving space includes a platform.

5. The box of claim 1, wherein the indented receiving space includes a ledge along an inside wall of the lid.

6. The box of claim 1, wherein the interchangeable insert is secured to the indented receiving space using one of adhesion, and tight fit.

7. The box of claim 1, wherein the interchangeable insert and the indented receiving space each has a shape with a plurality of sides.

8. The box of claim 1, wherein the interchangeable insert and the indented receiving space each has a substantially round shape.

9. The box of claim 1, wherein the interchangeable insert is made from plastic.

10. A container with interchangeable insert, comprising:
a bottom part;
a top part having an indented receiving space that is shaped and sized to receive an interchangeable insert; and
the interchangeable insert shaped and sized to fit into the indented receiving space.

11. The container of claim 10, wherein the indented receiving space has a depth substantially equal to a thickness of the interchangeable insert.

12. The container of claim 10, wherein the indented receiving space has a depth not equal to a thickness of the interchangeable insert.

13. The container of claim 10, wherein the indented receiving space includes a platform.

14. The container of claim 10, wherein the indented receiving space includes a ledge along an inside wall of a lid.

15. The container of claim 10, wherein the interchangeable insert is secured to the indented receiving space using one of adhesion, hook and loop and tight fit.

16. The container of claim 10, wherein the interchangeable insert and the indented receiving space each has a shape with a plurality of sides.

17. The container of claim 10, wherein the interchangeable insert and the indented receiving space each has a substantially round shape.

18. The container of claim 10, wherein the interchangeable insert is made from one of metal and plastic.

19. The box of claim 1, wherein the interchangeable insert is made from metal.

20. The box of claim 1, wherein the interchangeable insert is secured to the indented receiving space using hook and loop material.
